(19) United States
(12) Patent Application Publication
(10) Pub. No.: US 2011/0274492 A1
(43) Pub. Date: Nov. 10, 2011

(54) DRILLED UNDERGROUND GASEOUS STORAGE SYSTEM

(75) Inventors: Puneet Verma, McLean, VA (US); Amily C. Chuang, Houston, TX (US); Tecle Rufael, Sugar Land, TX (US)

(73) Assignee: Texaco Inc., San Ramon, CA (US)

(21) Appl. No.: 12/775,065

(22) Filed: May 6, 2010

(51) Int. Cl. B65G 5/00; E21B 7/00

(52) U.S. Cl. 405/53; 175/57

(57) ABSTRACT

The present invention discloses embodiments of a drilled underground gaseous storage system. The embodiments of the present invention comprise storage tubes inserted below the surface of the ground for the storage of gases. The embodiments of the present invention may be used to store gaseous hydrogen. In addition, the embodiments of the present invention many be used to store other gases such as compressed natural gas.

### FIELD OF THE INVENTION

The present invention relates generally to the storage of gases and in particular to a drilled underground gaseous storage system.

### BACKGROUND OF THE INVENTION

Hydrogen is utilized in a wide variety of settings ranging from industrial, medical and commercial settings such as the aerospace industry, food production, and oil and gas production and refining. Hydrogen is used in these settings as a propellant, an atmosphere, a carrier gas, a diluents gas, a fuel component for combustion reactions, a fuel for fuel cells, as well as a reducing agent in numerous chemical reactions and processes. In addition, hydrogen is being considered as an alternative fuel for centralized and distributed power generation as well as transportation vehicles because it is clean, abundant, efficient, and unlike other alternatives, produces zero emissions. While there is wide-spread consumption of hydrogen and great potential for even more, a disadvantage which inhibits further increases in hydrogen consumption is the absence of a hydrogen economy to provide widespread generation, storage and distribution.

One way to overcome this difficulty is through the operation of hydrogen refueling stations. At hydrogen refueling stations, hydrogen generators, such as reformers, electrolyzers, bioreactors or photocatalysts are used to convert hydrocarbons to a hydrogen rich gas stream. Hydrocarbon-based fuels, such as natural gas, LPG, gasoline, and diesel, require conversion processes to be used as fuel sources for most fuel cells. The gaseous hydrogen is then compressed and stored in stationary storage tanks at the hydrogen refueling stations to provide inventory to fuel internal combustion engines and fuel cell vehicles. In addition, instead of being generated at the hydrogen refueling station, gaseous hydrogen may be transported to the hydrogen refueling station for storage and distribution.

Storage capacity for the storage of gaseous hydrogen at hydrogen refueling stations has been a major challenge in the development of a hydrogen economy. The hydrogen refueling station must provide sufficient storage capacity for the hydrogen fuel without incurring significant costs.

Due to their significantly lower density, gases generally require a much larger volume to store than liquids. Hydrogen has the lowest density of any gas. Therefore, storage capacity for gases is often limited by the amount of space or area available. In many cases, gases are stored in high pressure storage vessels in order to increase the storage mass for a fixed volume.

Purified hydrogen gas is stored at pressures of greater than 5,000 psig at a hydrogen refueling station. At higher pressures, storage vessels become more and more difficult to manufacture and also exponentially more expensive. Even at such high pressure, the storage vessel still occupies considerable space. In addition, there is a potential safety hazard associated with the high pressure storage vessels. Since most hydrogen refueling stations are expected to be located in urban areas with higher fuel demand but also higher real estate cost, alternatives to the typically above ground high pressure storage vessels are needed for the hydrogen economy.

One possible alternative is to bury the storage vessels underground. However, this alternative has some drawbacks. For example, excavation can be costly, the space available is limited by the practical depth that can be excavated without compromising the structural integrity of the foundation, and burying high pressure vessels further increases fuel storage system costs. Therefore, additional alternatives for addressing the challenges of storing gases are still needed.

### SUMMARY OF THE INVENTION

In the present invention embodiments of a drilled underground gaseous storage system (“DUGSS”) are disclosed. The embodiments of the drilled underground storage system of the present invention comprise storage tubes inserted below the surface of the ground for the storage of gases. The embodiments of the present invention may be used for the storage of gaseous hydrogen as well as for the storage of other gases.

The embodiments of the present invention also disclose both methods for the installation of the drilled underground gaseous storage system of the present invention and methods for storing gases utilizing the drilled underground storage system of the present invention.

### BRIEF DESCRIPTION OF THE FIGURES

The description is presented with reference to the accompanying figures in which:

FIG. 1 shows one embodiment of the drilled underground gaseous storage system of the present invention.

### DETAILED DESCRIPTION OF THE INVENTION

The present invention discloses embodiments of a drilled underground gaseous storage system. The embodiments of the present invention may be used to store gaseous hydrogen. In addition, the embodiments of the present invention many be used to store other gases such as compressed natural gas, helium, argon, air, carbon dioxide, nitrogen, and oxygen.

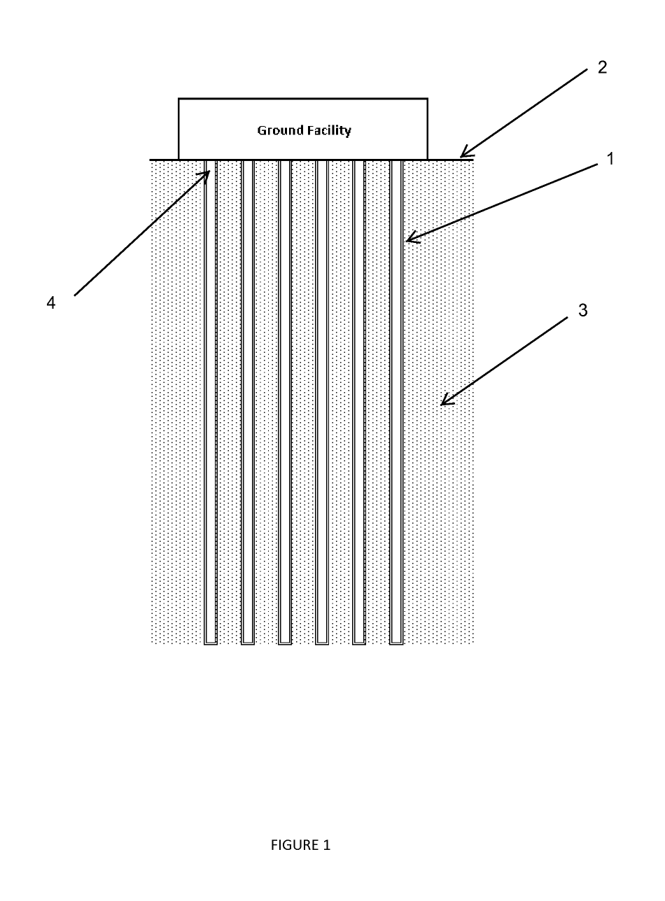

With reference to FIG. 1, FIG. 1 depicts one embodiment of the drilled underground gaseous storage system of the present invention. In one embodiment of the present invention, storage tubes 1 are inserted vertically (as shown in FIG. 1), or at an angle (not shown), into the ground 3 for gaseous storage. In the vertical insertion embodiment, the storage tube is substantially perpendicular to the surface of the ground. In the angled insertion embodiment, the storage tube is between perpendicular and parallel to the ground. The storage tubes 1 will be capable of storing a gas.

To install the drilled underground gaseous storage system of the present invention, bore holes 4 will be drilled below the surface 2 of the ground 3 to accommodate the storage tubes 1 that will be inserted into the bore holes 4. One storage tube 1 will be inserted into each bore hole 4. The number of bore holes 4 and the size of the storage tubes 1 will depend on the storage needs of the specific situation.

The embodiments of the present invention utilize residential geothermal or water well drilling technology to create the bore holes for the underground storage space. Residential geothermal and water well drilling technology is well known in the art. Although the purposes for the drilling are different, the equipment used and the drilling operations are essentially the same for both residential geothermal and water well drilling. In general, the only difference is the drill size. Typically the drill size ranges from 3 inches to 8 inches in diameter in residential geothermal drilling. In comparison, typically the drill size ranges from 12 inches to 16 inches in diameter for water well drilling. Holes with larger diameters can also be drilled using industrial oil and gas drilling equipment; however, this could be a more expensive option. In addition, from a scheduling perspective, residential geothermal and water well drilling could likely be easier to obtain through local contractors.

Typically residential geothermal and water well drilling equipment can reach depths of up to 500 to 1000 feet. However, transportation of the storage tubes may be difficult once they exceed a certain length. Therefore, as an alternative, in one embodiment of the present invention the storage tubes can be assembled from pipe segments onsite during installation as they are inserted into the bore holes. Special equipment or casing may be required to hold the unfinished storage tube, which is suspended in the bore hole, in place when the next pipe segment is being added on. Each pipe segment may be connected linearly by connecting means such as welds, screws, or a chemical seal in order to achieve the desired length. When each connection is completed and inspected, the unfinished storage tube is inserted further down the hole by one pipe segment before another pipe segment is added.

As noted above, during the design phase of the embodiments of the drilled underground gaseous storage system of the present invention, the length, diameter and material (including the grade of material) of the storage tubes may be varied and should be optimized based on the type of gas, geotechnical analysis of the ground, storage capacity requirement, available area, hole spacing, and the overall economics. Materials capable of storing gases include but are not limited to steel, copper, and pvc (polyvinyl chloride or “plastic”).

In one example of the present invention, a drilled underground gaseous storage system is designed for a demonstration hydrogen refueling station for 300 kg of gaseous hydrogen storage. Note that the data presented here is only illustrative and is not to be used in actual storage design or cost estimation.

Regarding storage design, columns 3, 4, and 5 of the below table represent 8, 10, and 12 inch seamless pipes 500 feet long respectively. Column 6 represents the existing storage configuration which consists of above ground storage vessels each 16 inches in diameter and 25 feet long.

Results

| | | # of cylinders | | | |
|---|---|---|---|---|---|
| | | 7 | 4 | 3 | 19 |
| total steel weight | ton | 93.6 | 67.7 | 72.2 | 82.1 |
| approx. area | ft² | 97 | 61 | 50 | 357 |

As the data in the above table illustrates, the approximate above surface area required for storage is greatly reduced from 357 ft² to as small as 50 ft².

Regarding cost, the drilled underground gaseous storage system of the present invention will also offer considerable cost reduction. The normalized cost (per kg of gaseous hydrogen stored) for a demonstration hydrogen station for 300 kg of gaseous hydrogen storage in steel vessels is approximately $2000/kg. In comparison, the normalized cost of the drilled underground gaseous storage system in steel vessels is shown in the table below.

Normalized Cost ($/kg H2 stored)

| | | pressure, psig | | | | | | |
|---|---|---|---|---|---|---|---|---|
| | | 500 | 1000 | 2000 | 3000 | 4000 | 5000 | 6000 |
| depth, | 200 | $4,614 | $2,794 | $1,677 | $1,515 | $1,498 | $1,381 | $1,478 |
| feet | 400 | $3,829 | $2,371 | $1,447 | $1,339 | $1,346 | $1,249 | $1,351 |
| | 600 | $3,567 | $2,230 | $1,370 | $1,281 | $1,296 | $1,205 | $1,309 |
| | 800 | $3,436 | $2,159 | $1,332 | $1,252 | $1,271 | $1,184 | $1,288 |
| | 1000 | $3,357 | $2,117 | $1,309 | $1,234 | $1,256 | $1,170 | $1,275 |

diameter = 10 inches

The cost savings come mainly from the long storage tubes formed by connecting pipes linearly, instead of factory-manufactured high pressure ASME vessels. Furthermore, the cost figures shown have not taken into account the potential savings on real estate from utilizing the surface area directly above the underground storage tubes, as the real estate values vary from one location to another. In areas with high real estate values, the embodiments of the present invention method would be even more economically favorable.

As shown above, the embodiments of the present invention will increase storage capacity per square foot of surface footprint addressing the area and depth challenges related to above ground storage and underground storage by excavation, respectively.

In addition, as shown above, the embodiments of the present invention will reduce the cost of the gaseous storage system. The cost analysis on hydrogen storage in particular demonstrates that this innovative storage method can significantly reduce the cost per kg of hydrogen gas stored.

Further, the embodiments of the present invention will also result in improved safety. Since there is minimal accessibility to the storage tubes once they are inserted and grouted in the bore holes, it provides an inherent safety barrier against tempering, accidental collision, and fire, all of which have been major concerns in the design and operation of many above-ground storage facilities, especially when flammable/combustible fluids such as hydrogen are stored.

While the methods of this invention have been described in terms of preferred or illustrative embodiments, it will be apparent to those of skill in the art that variations may be applied to the process described herein without departing from the concept and scope of the invention. All such similar substitutes and modifications apparent to those skilled in the art are deemed to be within the scope and concept of the invention as it is set out in the following claims.

What is claimed is:

1. A drilled underground gaseous storage system comprising:
at least one storage tube inserted below a surface of a ground wherein said at least one storage tube stores a gas.

2. The system of claim 1 wherein said at least one storage tube is inserted below the surface of the ground vertically.

3. The system of claim 1 wherein said at least one storage tube is inserted below the surface of the ground at an angle.

4. The system of claim 1 wherein said gas is hydrogen.

5. The system of claim 4 wherein said drilled underground gaseous storage system is located at a hydrogen refueling station.

6. The system of claim 1 wherein said gas is natural gas.

7. The system of claim 1 wherein said gas is carbon dioxide.

8. The system of claim 1 wherein said gas is nitrogen.

9. A method for installing a drilled underground gaseous storage system comprising:
drilling one or more bore holes below a surface of a ground;
inserting a storage tube into each of said one or more bore holes wherein said storage tube is capable of storing a gas.

10. The method of claim 9 wherein said drilling is vertical.

11. The method of claim 9 wherein said drilling is at an angle.

12. The method of claim 9 wherein said storage tube comprises more than one pipe segments.

13. The method of claim 12 wherein said more than one pipe segments are connected onsite during said inserting into said one or more bore holes.

14. A method for storing gases utilizing a drilled underground gaseous storage system comprising:
storing a gas in at least one storage tube inserted below a surface of a ground.

15. The method of claim 14 wherein said storage tube is inserted below the surface of the ground vertically.

16. The method of claim 14 wherein said storage tube is inserted below the surface of the ground at an angle.

17. The method of claim 14 wherein said gas is hydrogen.

18. The method of claim 14 wherein said gas is natural gas.

19. The method of claim 14 wherein said gas is carbon dioxide.

20. The method of claim 14 wherein said gas is nitrogen.
